(19) United States
(12) Patent Application Publication
(10) Pub. No.: US 2023/0267089 A1
(43) Pub. Date: Aug. 24, 2023

(54) Compute Platform Architecture For Secure And Efficient Deployment Of Cloud Native Communication Network Functions

(71) Applicant: Google LLC, Mountain View, CA (US)

(72) Inventors: Santanu Dasgupta, Fremont, CA (US); Durgaprasad V. Ayyadevara, San Ramon, CA (US); Bor Chan, Fremont, CA (US); Prashant R. Chandra, San Jose, CA (US); Bok Knun Randolph Chung, Los Altos, CA (US); Max Kamenetsky, Palo Alto, CA (US); Rajeev Koodli, Saratoga, CA (US); Shahin Valoth, Santa Clara, CA (US)

(21) Appl. No.: 18/112,740

(22) Filed: Feb. 22, 2023

Related U.S. Application Data
(60) Provisional application No. 63/312,662, filed on Feb. 22, 2022.

(51) Int. Cl. G06F 13/38; G06F 13/12

(52) U.S. Cl. CPC G06F 13/385; G06F 13/122; G06F 2213/0038

(57) ABSTRACT

The present disclosure provides a compute platform architecture for virtualized and cloud native network functions. The architecture uses a reduced instruction set computer-based general purpose processor along with multiple special purpose accelerators and an integrated network interface card. As such, the architecture can accommodate multiple hundreds of gigabits of input/output.

### CROSS-REFERENCE TO RELATED APPLICATIONS

The present application claims the benefit of the filing date of U.S. Provisional Patent Application No. 63/312,662 filed Feb. 22, 2022, the disclosure of which is hereby incorporated herein by reference.

### BACKGROUND

Communication Service Providers (CSPs) worldwide are embracing disaggregation, cloud, automation and machine learning (ML)/artificial intelligence (AI) to achieve software centricity to become agile and customer experience centric. CSPs are virtualizing various network functions, leveraging cloud native technologies across all domains of end-to-end systems architecture. An initial phase started with operations support system and business support system (OSS/BSS) that are typically deployed centrally in a CSP network, and in later phases, virtualization expanded to the core network at regional data centers or service edge of the CSP.

Traffic over the Internet is doubling almost every 2 years, and in order to maintain a proper balance between supply and demand, the computing infrastructure also needs to be doubled every 2 years. However, the density of transistors within the same sized Integrated Circuit (IC) and at the same power footprint and at the same cost is no longer doubling anymore, which can create an imbalance where the supply may not be able to keep up with the traffic demand anymore in a cost and power efficient manner BRIEF SUMMARY

The present application relates to deployment of virtualized/containerized network functions. An example relates to a virtualized distributed unit (vDU) of a 4G or 5G Radio Access Network (RAN). Virtual distributed unit (vDU) network functions of 4G/5G radio access networks (RAN) involves deployment of physical layer, scheduler and data link layer including the control components of the data link. Given the involvement of lower layer components of the protocol stack, the vDU poses extremely stringent requirements for computing around high bandwidth with no packet loss, extreme low latency, predictability, reliability and security. Some of these requirements create the need for the cloud infrastructure to deliver real-time performance Wireline access networks such as cable modem termination system (CMTS) in a cable network may have similar system requirements. To address such requirements in existing systems, vDUs are deployed on top of general purpose processors (GPP), often alongside a lookaside acceleration building block to offload very high compute intensive processing such as the computation of forward error correction. The incoming traffic in such arrangements comes in through a dedicated network interface controller (NIC), followed by the GPP based central processing unit (CPU) processing the physical layer functions (Hi-PHY) including lookaside acceleration to process channel coding or forward error correction (FEC), followed by the GPP based CPU again that processes the scheduler and data link layer functions.

The present disclosure provides a common and horizontal telephone communication (telco) cloud infrastructure that can form the foundation for virtualization of both wireless networks, such as 4G and 5G and other radio access networks (RANs), and wirelines access networks, such as cable/fiber based broadband networks. Such infrastructure can be deployed in a highly distributed manner across hundreds of thousands of sites. Such infrastructure may provide an agile, secure and efficient platform to deploy all network and information technology (IT) functions in a seamless manner Such infrastructure may also provide higher performance and lower power consumption, while also bringing in newer capabilities to address artificial intelligence and security challenges in the new world.

A compute platform architecture described herein provides for secure and efficient deployment of CSP network functions, particularly for access networking like 4G & 5G RAN, cable and fiber broadband. The compute platform architecture may be modular, with a host computer as a main building block along with an optional L1 processor as a PCIe device.

The present disclosure further provides a compute platform architecture for virtualized and cloud native network functions. The architecture uses a reduced or complex instruction set computer-based general purpose processor along with multiple special purpose accelerators and an integrated network interface card. As such, the architecture can accommodate multiple hundreds of gigabits of input/output.

### BRIEF DESCRIPTION OF THE DRAWINGS

FIG. 1 is a pictorial diagram illustrating example 5G deployment models.

FIG. 2 is a block diagram illustrating an example framework enabling a cloud provider to service 5G models according to aspects of the disclosure.

FIG. 3 is a block diagram illustrating an example cloud platform architecture for cloud service provider network functions according to aspects of the disclosure.

FIGS. 4A and 4B provide front and top views, respectively, of a physical implementation of the example cloud platform of FIG. 3 in a server platform in a rack according to aspects of the disclosure.

FIG. 5 is a block diagram illustrating another example compute platform architecture for CSP network functions according to aspects of the disclosure.

FIG. 6 illustrates an example of how processing may be performed in the architecture 500 described in connection with FIG. 5.

### DETAILED DESCRIPTION

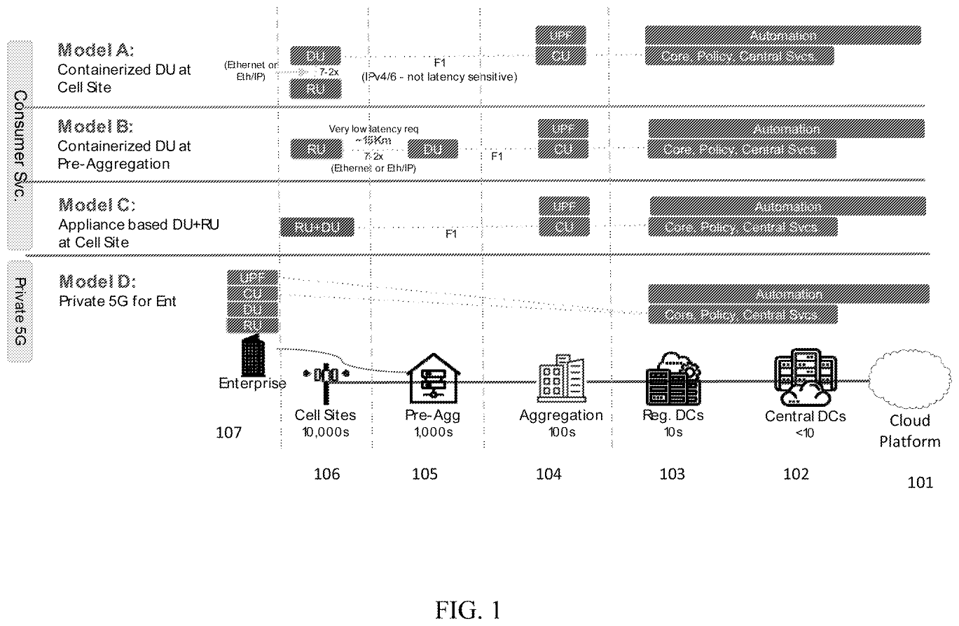

FIG. 1 illustrates example 5G deployment models. A cloud platform 101 supports a hierarchy of sites, including central datacenters 102, regional datacenter 103, aggregation sites 104, pre-aggregation sites 105, cell sites 106, and in some instances enterprise 107. There may be a relatively small number of central datacenters 102 and more regional datacenters 103. For example, the cloud platform 101 may support approximately 10 or fewer central datacenters 102 and tens or dozens of regional datacenters 103. Aggregation 104 may be on the order of hundreds, and pre-aggregation 105 may be on the order of thousands. By way of example only, there may be a hundred or several hundred aggregation sites 104, and a thousand or several thousand pre-aggregation sites 105. Such systems service cell sites 106, which may be on the order of tens of thousands.

In each of models A-D, automation, core, policy, and central services occur at the level of cloud platform 101, central datacenters 102, and regional datacenters 103. In each of models A-C, a user plan function (UPF) and centralized unit (CU) are at the aggregation 104. In model A, a containerized distributed unit (DU) is positioned at the cell sites 106. The cell site 106 includes a radio unit (RU), which may be used to establish radio connectivity with user devices. In model B, the DU is at the pre-aggregation 105 level. In each of models A and B, the DU is a containerized or virtualized application, while the RU is a physical appliance. In model C, the RU and DU are both physical appliances at the cell site 106 level.

In model D, private 5G is provided for enterprise 107. The enterprise 107 may be, for example, a company or organization. In this model, the UPF, CU, DU are all containerized or virtualized applications at the enterprise, and the RU is a physical appliance at the enterprise.

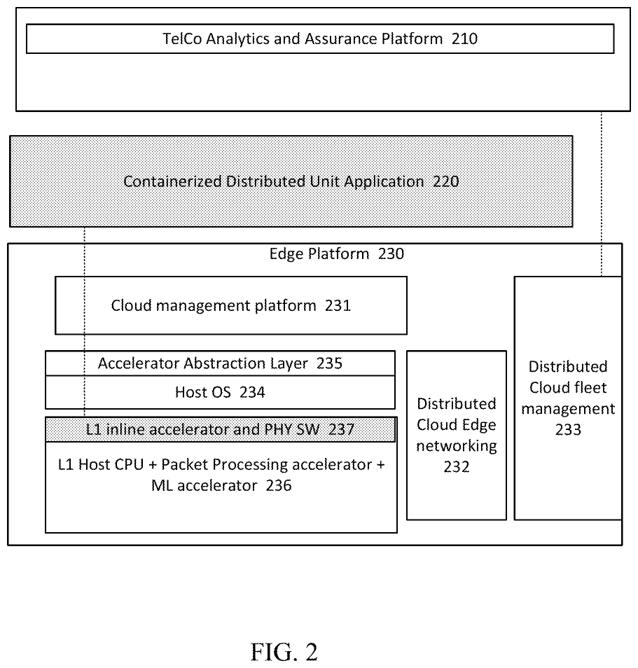

FIG. 2 is a block diagram illustrating an example framework enabling a cloud provider to service 5G models, such as models A, B, and D discussed in connection with FIG. 1, with increased efficiency and security. The framework includes a telco analytics and assurance platform (TAAP) 210 in communication with a cloud edge platform 230. The cloud edge platform 230 may include a cloud management platform 231, a distributed cloud edge networking engine 232, and a distributed cloud fleet management engine 233. The edge platform 230 may further include a host operating system (OS) 234. An accelerator abstraction layer (AAL) 235 exists on top of the host OS 234. The AAL 235 may be controlled by the cloud platform or by a third party. The edge platform 230 may further include a host CPU unit 236, including a packet processing accelerator and a ML accelerator. An L1 physical (PHY) accelerator and PHY software 237 may be executed by the host CPU 236. The PHY accelerator 237 may be controlled by a third party. A containerized DU application 220 may be controlled by a third party and communicatively coupled with the host CPU 236. As one example, the containerized DU application 220 may be a RAN of an independent software vendor (ISV).

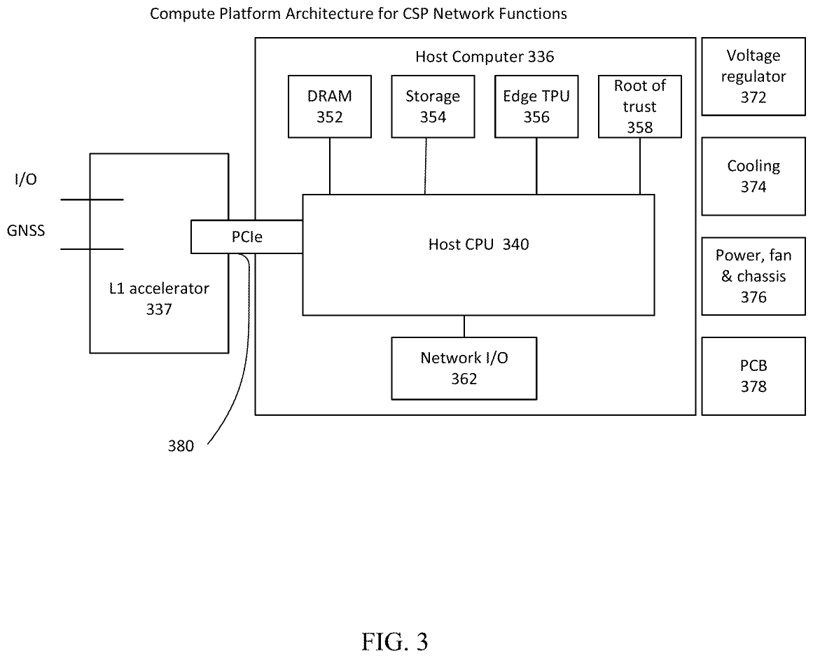

FIG. 3 illustrates another example cloud platform architecture for cloud service provider network functions. As shown in this example, host compute unit 336 is coupled with an L1 accelerator 337 through a PCIe bus 380.

Host compute unit 336 includes host CPU 340 in communication with DRAM 352, storage 354, edge tensor processing unit (TPU) 356 or other machine learning accelerator, processor, or hardware unit, and root of trust 358. The host CPU 340 is further in communication with network I/O 362.

The host CPU 340 may be, for example, an application specific integrated circuit (ASIC) including a plurality of processing cores. By way of example, the host CPU 340 may include a NIC ASIC. The host CPU 340 may include any number of processing cores, such as 8, 16, 24, 32, 36, 48, 64, etc. According to other examples, the host CPU 340 may be any of a variety of other types of processing units, such as a graphics processing unit (GPU), a field programmable gate array (FPGA), a microprocessor, etc. The host CPU 340 can be implemented on a computing device, which itself may be part of a system of one or more devices. The host CPU 340 may include a plurality of processors that may operate in parallel.

The DRAM 352 may be any type of dynamic random access memory, such as a DDR4 memory chip or the like. According to some examples, the DRAM 352 may include multiple DRAM devices. While DRAM is illustrated in FIG. 3, in other examples other types of memory may be used. Such memory can store information accessible by the host CPU 340, including instructions executable by the host CPU 340, and data that can be retrieved, manipulated, or stored by the host CPU 340. Such memory can be a type of non-transitory computer readable medium capable of storing information accessible by the processors, such as volatile and non-volatile memory.

The instructions can include one or more instructions that when executed by the processors, causes the one or more processors to perform actions defined by the instructions. The instructions can be stored in object code format for direct processing by the processors, or in other formats including interpretable scripts or collections of independent source code modules that are interpreted on demand or compiled in advance.

The data can be retrieved, stored, or modified by the processors in accordance with instructions. The data can be stored in computer registers, in a relational or non-relational database as a table having a plurality of different fields and records, or as JSON, YAML, proto, or XML documents. The data can also be formatted in a computer-readable format such as, but not limited to, binary values, ASCII, or Unicode. Moreover, the data can include information sufficient to identify relevant information, such as numbers, descriptive text, proprietary codes, pointers, references to data stored in other memories, including other network locations, or information that is used by a function to calculate relevant data.

The storage 354 may include can include any type of non-transitory computer readable medium capable of storing information, such as a hard-drive, solid state drive, tape drive, optical storage, memory card, ROM, RAM, DVD, CD-ROM, write-capable, and read-only memories. For example, the storage 354 may include a solid state drive (SSD), hard disk drive (HDD), Non Volatile Memory Express (NVMe) etc. According to some examples, the storage 354 may include any combination of volatile and non-volatile memory.

The edge TPU 356 may be, for example, an ASIC designed to run AI at an edge of a cloud framework. According to other examples, the TPU 356 may be an FPGA, general purpose CPU, or other processing unit.

The root of trust 358 may be, for example, a hardware or software module ensuring that connected components can be trusted. For example, the root of trust 358 may be a security component that ensures devices communicating with the host compute 336 have a valid certificate.

The network input/output (I/O) 362 may include any of a variety of I/O interfaces. For example, the I/O 362 may include multiple interfaces of different types for communication with different devices.

The host compute module 336 may operate in coordination with other components of a system, such as voltage regulator 372, cooling module 374, power 376, printed circuit board (PCB) 378, etc.

The L1 accelerator 337 may also have an I/O interface. The L1 accelerator 337 may perform digital signal processing of the physical layer function of the networking protocol stack. According to some examples, the accelerator 337 communicates with global navigation satellite system (GNSS).

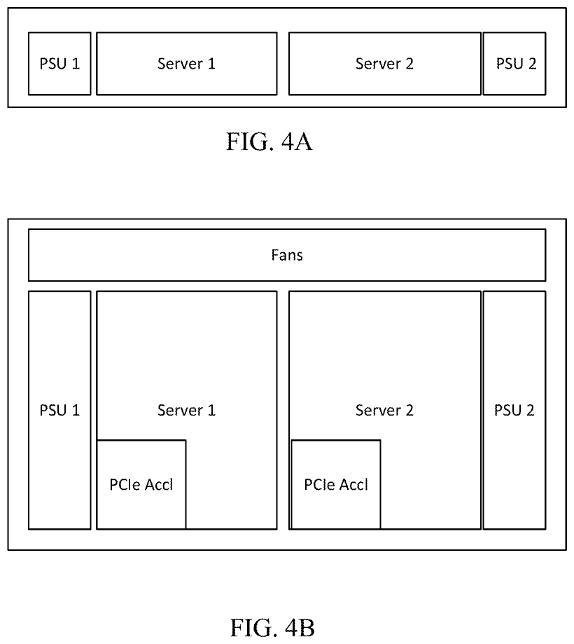

FIGS. 4A and 4B provide front and top views, respectively, of a physical implementation of a server platform in a rack. As shown, Server 1 and Server 2 are powered by respective power supply units (PSUs) positioned adjacent the respective servers in the rack. Fans are also included in the rack, providing cooling for the Servers 1 and 2. Each of Server 1 and Server 2 include a respective PCIe accelerator. The PCIe accelerator may be, for example, the L1 accelerator 337 of FIG. 3. Such accelerator may be a third party component included in the servers.

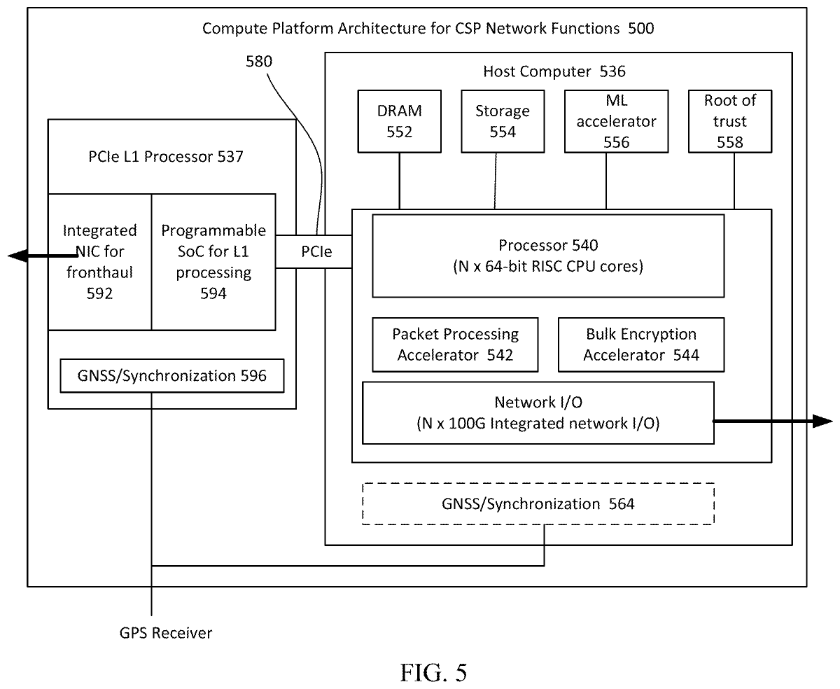

FIG. 5 illustrates another example compute platform architecture 500 for CSP network functions. The architecture 500 provides for secure and efficient deployment of CSP network functions, particularly for access networking like 4G & 5G RAN, cable and fiber broadband. The compute platform architecture 500 may be modular, with a host computer 536 as a main building block along with an optional L1 processor 537 as a PCIe device.

The PCIe L1 processor 537 may have an integrated network interface card (NIC) capability 592 for integrated network input/output (IO); along with a programmable, high performant and power efficient layer 1 packet and/or digital signal processor 594 that can process all functions of the physical layer so that any GPP based CPU can focus on the remaining tasks. Accessing networking functions in CSP networks can have very stringent latency and time-sensitive requirements. In order to provide high precision timing synchronization, the PCIe L1 processor can also have a synchronization building block 596 on the module with relevant silicon constructs like digital phase locked loop (DPLL), GNSS receiver etc. The PCIe L1 processor 537 may be, for example, a software based abstraction of L1 processor. Such software based abstraction may make it easy for Network Function application developers to easily port from one hardware construct to another.

The host compute module 536 is the hub of the architecture that connects itself with the optional PCIe L1 processor 537 over multiple PCIe lanes 580. Such PCIe lanes 580 may be Generation 3, 4, 5, 6, etc.

The host compute module 536 includes a processor 540. The processor 540 may be, for example, a next-generation programmable and hybrid processor. By way of example only, the processor 540 may be a combination of an energy efficient 64-bit reduced instruction set computer (RISC) or Complex Instruction Set Computer (CISC) based GPP CPU plus an integrated NIC with multiple hundreds of Gigabits of network I/O plus multiple special purpose packet processors. The special purpose packet processors may augment the processing to derive a great balance of flexibility, performance, power consumption, and cost.

One example of such special purpose processors include a bulk encryption accelerator 544 providing for bulk encryption of all traffic over all network I/O using IP Security (IPSEC) at multiples of 100 Gigabits of speed. Another example of the special purpose processors includes a packet processing accelerator 542 that can \perform packet processing and forwarding of IP traffic at line rate. The architecture however is not limited to only these two examples and can have more capabilities in the similar lines. The bulk encryption accelerator 544 may be used, for example to encrypt/decrypt all network traffic from the system.

The processor 540 with the integrated NIC, along with the special purpose processors like packet processing accelerator 542 and bulk encryption accelerator 544 et al. can be packaged in a System-on-a-Chip (SoC) packaging for maximized performance and efficiency of power utilization.

The host compute module 536 also includes an onboard ML accelerator 556. The ML accelerator 556 may perform inferencing at the edge along with other functions such as DRAM 552, storage 554 and hardware root of trust 558 for enhanced trust/security of the disaggregated platform. The storage 554 can be onboard or may reside on a separate physical device. The DRAM 552, storage 554, and root of trust 558 may be similar to the DRAM 352, storage 354, and root of trust 358 described above in connection with FIG. 3. An optional GNSS receiver and time sync capability 564 may also exist on the host compute module 536.

The architecture 500 may be implemented in any of a variety of forms of hardware. According to one example, the architecture 500 may be implemented as a system on chip (SoC). According to other examples, the architecture 500 may be implemented in one or more servers in a rack. According to further examples, the architecture 500 may be implemented in any one or multiple computing devices.

While a number of components of the architecture 500 are illustrated, it should be understood that these are merely examples. Additional or fewer components may be included in other implementations, and components may be interchanged with other types of components. While some components are illustrated as being within a same box, such components need not reside within the same physical housing.

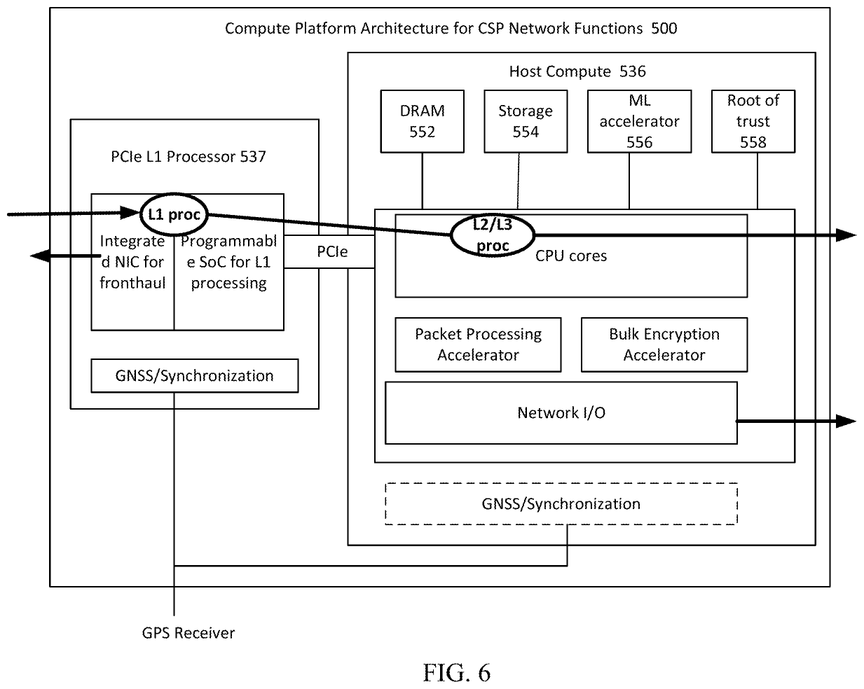

FIG. 6 illustrates an example of how processing may be performed in the architecture 500 described in connection with FIG. 5. As shown, L1 processing may be performed at the PCIe L1 processor 537. L2 and L3 processing may be performed at the host compute module 536.

The compute platform architecture described above may be programmed for virtualized and cloud native network functions. In some examples, such functions may utilize components in the architecture, such as a 64 bit RISC or CISC based GPP CPU along with multiple special purpose accelerators and integrated NIC for multiple 100 gigabits of I/O. CSP network access features such as DU, CMTS, broadband network gateway (BNG), etc. may be densely deployed on top of the compute architecture. The architecture provides for such deployment in a highly energy efficient and high performance manner.

Special purpose processors, such as the bulk encryption accelerator, provide an ability to perform line rate bulk encryption for multi 100 Gigabit IO in a SoC package to secure all incoming and outgoing interfaces of CSP access network functions, such as DU, CMTS, BNG and core functions like UPF or other Security Gateways. As one example, the bulk encryption can be performed with IPSEC. Energy efficient machine learning inferencing acceleration is provided for CSP access network functions like DU, CMTS, BNG when deployed alongside a RISC based GPP CPU.

The bulk encryption accelerator may be used to encrypt/decrypt all network traffic from the system. In some examples, CNF software on the system may operate with different L1/L2 accelerators with minimal modifications, through the use of a hardware abstraction layer. In further examples, a cloud based, intent-driven system securely and automatically manages the hardware and software on the computing modules.

The systems described above are advantageous in that they provide for increased efficiency of performance and power consumption, and efficient packaging of components. The architecture employs full inline acceleration where NIC is a bundled component of the processing complex. The system also provide for increased security. For example, by adding bulk inline encryption capability using IPSEC to all incoming and outgoing traffic at very high volume, adding lookaside encryption of all control and management plane traffic using hardware accelerated SSL, and adding hardware root of trust for better integrity of the overall system (HW and SW), security is improved.

Moreover, employing machine learning at the edge enables the network to become self driving, where ML inferencing becomes ubiquitous universally across the edge of the network. Hardware abstraction enables the network function application code to be ported easily from one hardware implementation to another.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A system, comprising:
a host computing module, comprising:
one or more processors;
one or more special purpose packet processors; and
an integrated network input/output (I/O); and
a peripheral interconnect processor coupled with the host computing module via a peripheral interconnect bus;
wherein the peripheral interconnect processor is programmable for L1 processing; and
wherein the host computing module is programmable for L2 and L3 processing.

2. The system of claim 1, wherein the one or more special purpose packet processors comprise a packet processing accelerator and a bulk encryption accelerator.

3. The system of claim 1, wherein the one or more processors, one or more special purpose packet processors, and integrated network I/O are implemented in a system on chip (SoC).

4. The system of claim 1, wherein the one or more processors comprise a plurality of reduced instruction set computer (RISC) or complex instruction set computer (CISC) processing cores.

5. The system of claim 4, wherein the plurality of RISC or CISC processing cores comprises N×64-bit RISC or CISC processing cores.

6. The system of claim 1, wherein the integrated network I/O comprises N×100G integrated network I/O.

7. The system of claim 1, wherein the host computing module further comprises a machine learning accelerator.

8. The system of claim 1, wherein the host computing module further comprises a root of trust module.

9. The system of claim 1, wherein the host computing module further comprises a synchronization module.

10. The system of claim 9, wherein the peripheral interconnect processor and the host computing module are coupled with a GPS receiver.

11. The system of claim 1, wherein the peripheral interconnect processor comprises an integrated network interface controller.

12. The system of claim 1, wherein the peripheral interconnect processor comprises a programmable system on chip (SoC).

13. A programmable compute platform architecture, comprising:
a reduced instruction set computer (RISC) or CISC-based general purpose processor unit;
a plurality of special purpose processors; and
an integrated network interface card (NIC);
wherein the RISC or CISC-based general purpose processor unit, the plurality of special purpose processor, and the integrated NIC are adapted to together provide at least 100 gigabits of input/output.

14. The programmable compute platform architecture of claim 13, wherein the architecture is provided in a system on chip (SoC) package.

15. The programmable compute platform architecture of claim 14, further comprising communication service provider network functions deployed on top of the RISC or CISC-based general purpose processor.

16. The programmable compute platform architecture of claim 15, further comprising a software-based abstraction of a L1 processor.

17. The programmable compute platform architecture of claim 15, wherein the architecture is adapted to secure incoming and outgoing interfaces of communication service provider access network functions.

18. The programmable compute platform architecture of claim 17, wherein securing the incoming and outgoing interfaces comprises performing bulk line rate encryption.

19. The programmable compute platform architecture of claim 15, wherein the architecture is adapted to secure incoming and outgoing interfaces of core functions.

20. The programmable compute platform architecture of claim 15, wherein the architecture is adapted to perform machine learning inferencing acceleration for communication service provider network functions.
